(19) United States
(12) Patent Application Publication
(10) Pub. No.: US 2021/0224681 A1
(43) Pub. Date: Jul. 22, 2021

(54) LEARNING DEVICE, FORECASTING DEVICE, METHOD, AND PROGRAM

(71) Applicant: NIPPON TELEGRAPH AND TELEPHONE CORPORATION, Tokyo (JP)

(72) Inventors: Yusuke TANAKA, Tokyo (JP); Takuya NISHIMURA, Tokyo (JP); Hiroyuki TODA, Tokyo (JP)

(73) Assignee: NIPPON TELEGRAPH AND TELEPHONE CORPORATION, Tokyo (JP)

(21) Appl. No.: 15/734,209

(22) PCT Filed: May 30, 2019
(86) PCT No.: PCT/JP2019/021643

§ 371 Date: Dec. 1, 2020

(30) Foreign Application Priority Data
Jun. 4, 2018 (JP) 2018-107189

(51) Int. Cl. G06N 20/00; G06K 9/00; G06F 17/18

(52) U.S. Cl. CPC G06N 20/00; G06F 17/18; G06K 9/00335

(57) ABSTRACT

A movement means label can be applied with good precision to a movement locus of which movement means is unknown, using a trained classifier. Filtering is performed on movement loci, including coordinates at each time of day, and of which the movement means are unknown, using parameters relating to a Gaussian process and parameters relating to noise, learned beforehand for each movement means label, and a feature vector is extracted from filtering results of the movement locus for each movement means label, a probability representing which movement means label the movement locus is, is calculated using a classifier for identifying which movement means label the movement locus is, the classifier having been learned beforehand for each movement means label, and a prediction label for the movement locus is output on the basis of calculation results.

### TECHNICAL FIELD

The present invention relates to a learning device, a predicting device, a method, and a program, and more particularly relates to a learning device, a predicting device, a method, and a program for applying a movement means label to a movement locus.

### BACKGROUND ART

In recent years, a situation is emerging where large-scale acquisition of movement loci of users is becoming possible regardless of whether indoors or outdoors, due to development of GPS and wireless communication technology, and communication terminals such as smartphones and the like coming into widespread use.

A movement locus is a time series of observations, given in a form of a pair of positional coordinates (latitude and longitude, etc.) and time of day. Knowing movement means of users on each locus is advantageous. For example, types of navigation can be customized in accordance with the movement means. A user who is walking might be given suggestions on nearby eateries, and a user in a train might be presented with transfer guidance. However, manually applying labels representing movement means to all of large-scale movement loci is not realistic. Accordingly, when given a great amount of movement loci of users, estimation of movement means labels for each locus is an important issue. In the related art, on the basis of machine learning technology, a finite number of movement loci to which movement means labels are applied is taken as input and formulated as a supervised learning problem, and a classifier is configured for outputting prediction labels when a movement locus of which the movement means label is unknown is input (NPL 1). It has been proposed to extract and utilize various features from the movement locus (speed, angle of change in direction, etc.) at this time, in order to perform more highly precise classifier learning.

### CITATION LIST

### Non Patent Literature

[NPL 1] Y. Zheng, Q. Li, Y. Chen, X. Xie, and W. Ma, “Understanding. Transportation Modes Based on GPS Data for Web Applications”, ACM Transactions on the Web, 4(1). 1-36, 2010.

### SUMMARY OF THE INVENTION

### Technical Problem

The related art is capable of predicting a movement means label by using a trained classifier when a movement locus of which the movement locus label is unknown is input, by learning in advance tendencies of movement loci for each movement means (e.g., difference between velocity of walking and an automobile). The related art assumes that a movement locus does not contain observation noise at the time of the classifier learning. However, movement loci observed in the real world invariably contain observation noise. The greater the observation noise is, the more difficult appropriate calculation of features becomes in the related art, and accordingly highly-precise classifiers cannot be configured. Conceivable simple solutions to the above problem include applying outlier processing and filtering processing (denoising) in common to all movement means. However, the magnitude of observation noise included in a movement locus differs depending on the movement means. For example, it is assumed that observation noise will be greater when moving by train due to poor wireless communication quality, as compared to when walking. The related art has a problem in that learning of a high-precision classifier is difficult in a case where a movement locus contains observation noise and the magnitude of observation noise differs for each movement means, as described above.

The present invention has been made in order to solve the above problem, and accordingly it is an object thereof to provide a learning device, method, and problem, capable of performing appropriate denoising for each movement means, and performing learning of a classifier for applying movement means labels to movement loci with high precision.

It also is an object thereof to provide a predicting device, method, and problem, capable of applying movement means labels to movement loci of which the movement means is unknown with high precision, using a trained classifier.

### Means for Solving the Problem

In order to achieve the above object a learning device according to a first invention is configured including a filtering unit that, on the basis of each of movement loci applied with a movement means label and including coordinates for each time of day, estimates parameters relating to a Gaussian process in a case of assuming that the movement locus follows the Gaussian process and parameters relating to noise, for each movement means label, and performs filtering on the movement locus to which the movement means label has been applied, using the estimated parameters relating to the Gaussian process and parameters relating to noise, a feature extracting unit that extracts feature vectors from filtering results of the movement loci, for each of the movement loci, and a classifier learning unit that learns a classifier for identifying which of the movement means labels the movement locus is, on the basis of the feature vectors extracted regarding the movement loci to which the movement means labels are applied, for each movement means label.

A predicting device according to a second invention is configured including a filtering unit that performs filtering on movement loci, including coordinates for each time of day, and of which the movement means are unknown, using parameters relating to a Gaussian process and parameters relating to noise, learned beforehand for each movement means label, and a predicting unit that extracts a feature vector from filtering results of a movement locus for each movement means label, calculates a probability representing which of the movement means labels the movement locus is, using a classifier for identifying which of the movement means labels the movement locus is, the classifier having been learned beforehand for each movement means label, and outputs a prediction label for the movement locus on the basis of calculation results.

A learning method according to a third invention includes executing of a step of a filtering unit estimating, on the basis of each of movement loci applied with a movement means label and including coordinates for each time of day, parameters relating to a Gaussian process in a case of assuming that the movement locus follows the Gaussian process and parameters relating to noise, for each movement means label, and performing filtering on the movement locus to which the movement means label has been applied, using the estimated parameters relating to the Gaussian process and parameters relating to noise, a step of a feature extracting unit extracting feature vectors from filtering results of the movement loci, for each of movement loci, and a step of a classifier learning unit learning a classifier for identifying which of the movement means labels the movement locus is, on the basis of the feature vectors extracted regarding the movement loci to which the movement means labels are applied, for each movement means label.

A predicting method according to a fourth invention includes executing of a step of a filtering unit performing filtering on movement loci, including coordinates for each time of day, and of which the movement means are unknown, using parameters relating to a Gaussian process and parameters relating to noise, learned beforehand for each movement means label, and a step of a predicting unit extracting a feature vector from filtering results of a movement locus for each movement means label, and calculating a probability representing which of the movement means labels the movement locus is, using a classifier for identifying which of the movement means labels the movement locus is, the classifier having been learned beforehand for each movement means label, and outputting a prediction label for the movement locus on the basis of calculation results.

A program according to a fifth invention is a program causing a computer to function as components of the learning device according to the first invention, or the predicting device according to the second invention.

### Effects of the Invention

According to the learning device, method, and program of the present invention, parameters relating to a Gaussian process in a case of assuming that the movement locus follows the Gaussian process and parameters relating to noise are estimated on the basis of each of movement loci applied with a movement means label and including coordinates for each time of day, for each movement means label, filtering is performed on the movement locus to which the movement means label has been applied, using the estimated parameters relating to the Gaussian process and parameters relating to noise, feature vectors are extracted from the filtering results for each of the movement loci, and a classifier for identifying which of the movement means labels the movement locus is, is learned on the basis of the feature vectors extracted regarding movement loci to which movement means labels have been applied, for each movement means label, thereby yielding advantages in that appropriate denoising can be performed for each movement means, and the classifier for applying movement means labels to movement loci with good precision can be learned.

Also, according to the predicting device, method, and program according to the present invention, filtering is performed on movement loci, including coordinates for each time of day, and of which the movement means are unknown, using parameters relating to the Gaussian process and parameters relating to noise, learned beforehand for each movement means label, and feature vectors are extracted from filtering results of movement loci for each movement means label, and a probability representing which of the movement means labels the movement locus is, is calculated using a classifier for identifying which movement means label the movement locus is, for each movement means label, and prediction labels are output regarding movement loci on the basis of the calculation results, whereby a trained classifier can be used to apply movement means labels to movement loci of which movement means are unknown with good precision.

### BRIEF DESCRIPTION OF DRAWINGS

FIG. 1 is a block diagram illustrating a configuration of a learning device according to an embodiment of the present invention.

FIG. 2 is a block diagram illustrating a configuration of a predicting device according to the embodiment of the present invention.

FIG. 3 is a flowchart illustrating a learning processing routine in the learning device according to the embodiment of the present invention.

FIG. 4 is a flowchart illustrating a predicting processing routine in the predicting device according to the embodiment of the present invention.

FIG. 5 is a diagram illustrating an example of a search request and an example of an output example.

### DESCRIPTION OF EMBODIMENTS

An embodiment of the present invention will be described below in detail with reference to the Figures.

In the present embodiment, a learning device uses a finite number of movement loci to which movement means labels have been applied to learn a classifier for predicting a movement means label with regard to a movement locus of which the movement means is unknown. The learning device has functions of being able to learn the classifier while taking into consideration difference in magnitude of observation noise for each movement means. A predicting device predicts a movement means label for a movement locus of which the movement means is unknown, by using a trained classifier, on the basis of the magnitude of observation noise and features calculated from the movement locus.

The learning device independently applies Gaussian process regression (NPL 2) to movement loci to which each movement means label has been applied. Accordingly, the smoothness of the movement locus and magnitude of observation noise can be estimated at the same time for each movement means. Denoising (filtering) of the movement locus is performed using a prediction distribution of Gaussian process regression estimated for each for movement means. Various features (velocity, angle of change in direction, etc.) are calculated on the basis of the post-filtering movement locus, and a classifier (logistic regression, etc.) is learned with these as input. Thus, the learning device has functions of filtering taking into consideration difference in magnitude of noise for each movement means, and configuring a classifier using the results of the filtering.

As for effects of the learning device, the classifier can be appropriately learned even in a case where a movement locus that has different magnitudes of observation noise for each movement means is given. For example, if observation noise is small in a case of walking but observation noise is great in a case of a train, observation noise in each movement means can be appropriately found by learning Gaussian process regression at each movement means. Using a prediction distribution of Gaussian process regression to appropriately perform filtering of observation noise from the movement locus of each movement means, and calculating various types of features using the results thereof, enables the classifier to be appropriately learned without being influenced by noise such as outliers or the like.

The predicting device has functions of, when given a movement locus with unknown movement means, (1) performing filtering by trained Gaussian process regression for data of each movement means, and (2) inputting the result thereof to the trained classifier, thereby predicting unknown movement means labels.

As for effects of the predicting device, the classifier is configured combining (1) and (2), whereby prediction of movement means labels can be performed on the basis of features calculated from the movement locus, while taking into consideration the smoothness of the locus and magnitude of noise of the movement locus of which the movement means is unknown.

A specific configuration of the learning device and predicting device will be described below. The learning device and predicting device handle movement locus data measured by optional wireless communication technology such as GPS and the like in general, and can flexibly handle these without being dependent on measurement means or measurement conditions (sampling rates, locations, and so forth). A case of configuring a classifier for predicting labels of a movement locus of which movement means labels are unknown, under conditions of general movement loci (time series of observation given by a pair of positional coordinates (latitude and longitude, etc.) and time of day) and movement means labels applied to each movement locus having been given, and estimating the movement means, will be described below as an example.

### <Configuration of Learning Device According to Embodiment of Present Invention>

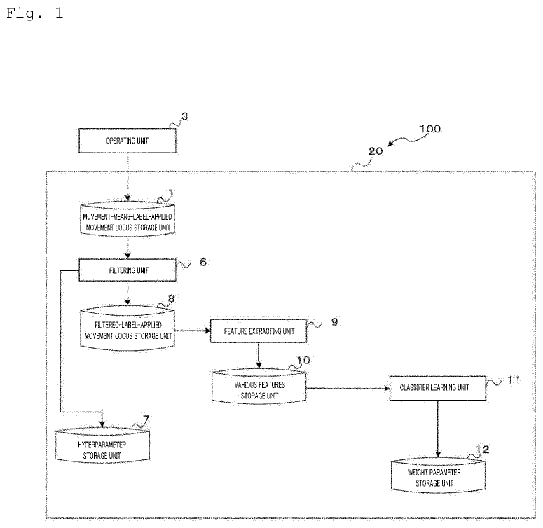

A configuration of the learning device according to the embodiment of the present invention will be described. The learning device 100 according to the embodiment of the present invention may be configured of a computer including a CPU, PAM, and ROM storing programs and various types of data for executing a later-described learning processing routine, as illustrated in FIG. 1. This learning device 100 functionally is provided with an operating unit 3 and a computing unit 20, as illustrated in FIG. 1.

The operating unit 3 accepts various types of operations from a user regarding data of a movement-means-label-applied movement locus storage unit 1. Various types of operations are operations of registering, editing, and deleting of stored information, and so forth. Input means of the operating unit 3 may be any arrangement, such as a keyboard or mouse, menu screen, arrangement using a touch panel, and so forth. The operating unit 3 is realized by a device driver of input means such as a mouse or the like, and control software for a menu screen.

The computing unit 20 is configured including the movement-means-label-applied movement locus storage unit 1, a filtering unit 6, a hyperparameter storage unit 7, a filtered-label-applied movement locus storage unit 8, a feature extracting unit 9, a various features storage unit 10, a classifier learning unit 11, and a weight parameter storage unit 12.

The movement-means-label-applied movement locus storage unit 1 stores data that may be used to learn a classifier for predicting movement means labels, reads out data following requests from the operating unit 3, and transmits this data to the filtering unit 6. C represents a movement means label set, and a movement means label is c∈C. Observations included in a movement locus of a movement means label c are represented by (tᵢⱼ^{(c)}, xᵢⱼ^{(c)}), which is a j'th observation included in an i'th movement locus. Note that here, tᵢⱼ^{(c)} represents observation time of day, and xᵢⱼ^{(c)} represents coordinate information. Also, xᵢⱼ^{(c)}=(uᵢⱼ^{(c)}, vᵢⱼ^{(c)}) holds, and represents points on a two-dimensional plane. Next, the i'th movement locus included in the movement means label c is Dᵢ^{(c)}={(tᵢⱼ^{(c)}, xᵢⱼ^{(c)})|j=1, . . . , Jᵢ^{(c)}}. Here, jᵢ^{(c)} represents the count of observations included in the i'th movement locus of the movement means label c. Also, the movement loci of the movement means label c are collectively represented by D^{(c)}={Dᵢ^{(c)}|i=1, . . . , I^{(c)}}. I^{(c)} here represents the count of movement loci of the movement means label c. Further the movement loci of all labels are collectively represented by D={D^{(c)}|c∈C}. Training data stored in the movement-means-label-applied movement locus storage unit 1 is D. The filtering unit 6 uses each of the movement loci in the training data D including coordinates for each time of day, to which movement means labels have been applied. The movement-means-label-applied movement locus storage unit 1 is a Web server, a database server provided with a database, or the like.

The filtering unit 6 estimates, for each movement means label, parameters relating to a Gaussian process in a case of assuming that the movement locus follows the Gaussian process, and parameters relating to noise, on the basis of each of movement loci applied with a movement means label and including coordinates for each time of day, stored in the movement-means-label-applied movement locus storage unit 1. The filtering unit 6 performs filtering on the movement locus to which the movement means label has been applied, using the parameters relating to the Gaussian process and parameters relating to noise estimated regarding the movement means label. Details will be described below.

Dᵢ^{(c)}={(tᵢⱼ^{(c)}), xᵢⱼ^{(c)})|j=1, . . . , Jᵢ^{(c)}}, which is an i'th movement locus when the movement means label is c, will be considered. It is assumed here that preprocessing of {tᵢⱼ^{(c)}|j=1, . . . , Jᵢ^{(c)}} has been performed at relative time from time of day 0 so that t_{i,j=1}^{(c)}=0 holds, and normalization processing has been performed so that in xᵢⱼ^{(c)}=(uᵢⱼ^{(c)}, vᵢⱼ^{(c)}), uᵢⱼ^{(c)} and vᵢⱼ^{(c)} each are independently 0 in average and have standard deviation of 1. f^{(c)} (t) and g^{(c)} (t) are noiseless potential functions as to uᵢⱼ^{(c)} and vᵢⱼ^{(c)}, and are assumed to each independently follow the Gaussian process. At this time, the Gaussian process that f^{(c)} (t) follows has an average of 0 and a correlation function that is following expression (1).

$$\begin{matrix}[ Formula 1 ] & \\ {k}_{u}^{( c )} ( t , {t}^{′} ) = {α}_{c}^{2} exp ( - \frac{2}{{γ}_{c}^{2}} {‖ t - {t}^{′} ‖}^{2} ) & ( 1 )\end{matrix}$$

The Gaussian process that g^{(c)} (t) follows has an average of 0 and a correlation function that is following expression (2).

$$\begin{matrix}[ Formula 2 ] & \\ {k}_{v}^{( c )} ( t , {t}^{′} ) = {β}_{c}^{2} exp ( - \frac{2}{{η}_{c}^{2}} {‖ t - {t}^{′} ‖}^{2} ) & ( 2 )\end{matrix}$$

Here, γ_{c}² and η_{c}² are scale parameters that decide the range of correlation with regard to points around the time of day t, and α_{c}² and β_{c}² are variance parameters that decide the magnitude of correlation. The scale parameters γ_{c}² and η_{c}² that decide the range of correlation with regard to points around the time of day t, and the variance parameters α_{c}² and β_{c}² that decide the magnitude of correlation, are an example of parameters relating to the Gaussian process.

expression (1) and expression (2) are called squared-exponential kernels, and are a type of correlation function most often used to measure similarity of data at spatial coordinates. When a time of day set {tᵢⱼ^{(c)}|j=1, . . . , Jᵢ^{(c)}}, contained in the i'th movement locus when the movement means label is c, is given, a joint distribution Jᵢ^{(c)} of

fᵢ^{(c)}=(f^{(c)}(t_{i,j=1}), . . . ,f^{(c)}(t_{i,j=J}_{ᵢ}_{^{(c)}}))^{T}

can be expressed by a Jᵢ^{(c)}-dimensional multidimensional Gaussian distribution, and can be written as expression (3) below.

[Formula 3]

fᵢ^{(c)}˜N(0,K_{u,i}^{(c)}) (3)

Here, K_{u,i}^{(c)} is a Jᵢ^{(c)}×Jᵢ^{(c)} matrix, of which the elements are K_{u,i}^{(c)} (j, j′)=Kᵤ^{(c)}=(tᵢⱼ^{(c)}, t_{ij′}^{(c)}). In the same way, when a time of day set {tᵢⱼ^{(c)})|j=1, . . . , Jᵢ^{(c)}}, contained in the i'th movement locus when the movement means label is c, is given, a joint distribution Jᵢ^{(c)} of

gᵢ^{(c)}=(g^{(c)}(t_{i,j=1}), . . . ,g^{(c)}(t_{i,j=J}_{ᵢ}_{^{(c)}}))^{T}

can be expressed by a Jᵢ^{(c)}-dimensional multidimensional Gaussian distribution, and can be written as expression (4) below.

[Formula 4]

gᵢ^{(c)}˜N(0,K_{v,i}^{(c)}) (4)

Here, K_{v,i}^{(c)} is a Jᵢ^{(c)}×Jᵢ^{(c)} matrix, of which the elements are K_{v,i}^{(c)}(j, j′)=Kᵤ^{(c)}=(tᵢⱼ^{(c)}, t_{i,j′}^{(c)}).

Next, assuming that actual observations

uᵢ^{(c)}=(u_{i,j=1}^{(c)}, . . . ,u_{i,j=J}_{ᵢ}_{^{(c)}}^{(c)})^{T}

and

vᵢ^{(c)}=(v_{i,j=1}^{(c)}, . . . ,v_{i,j=J}_{ᵢ}_{^{(c)}}^{(c)})^{T}

are obtained with Gaussian noise applied, uᵢ^{(c)} is a conditional probability that follows expression (5) below.

[Formula 5]

uᵢ^{(c)}|fᵢ^{(c)}˜N(fᵢ^{(c)},σ_{c}²I) (5)

vᵢ^{(c)} is a conditional probability that follows expression (6) below.

[Formula 6]

vᵢ^{(c)}|gᵢ^{(c)}˜N(gᵢ^{(c)},ξ_{c}²I) (6)

Here, I is an identity matrix. σ_{c}² and ξ_{c}² are variance parameters relating to noise. The variance parameters of σ_{c}² and ξ_{c}² relating to noise are an example of parameters relating to noise. Expression (3) and expression (5), and expression (4) and expression (6) each have conjugacy, whereby fᵢ^{(c)} and gᵢ^{(c)} can be analytically integrated out, and accordingly the marginal likelihood of uᵢ^{(c)} is expression (7) below.

[Formula 7]

uᵢ^{(c)}˜N(0,K_{u,i}^{(c)}+σ_{c}²I) (7)

The marginal likelihood of vᵢ^{(c)} is expression (8) below.

[Formula 8]

vᵢ^{(c)}˜N(0,K_{v,i}^{(c)}+ξ_{c}²I) (8)

Assuming that uᵢ^{(c)} and vᵢ^{(c)} are independent with regard to i of the movement locus ID, based on expression (7) and expression (8), the marginalized log-likelihood functions are expression (9) and expression (10) below.

$$\begin{matrix}[ Formula 9 ] & \\ log p ( ( {u}_{i}^{( c )} \vert i ∈ I \} \vert {α}_{c}^{2} , {γ}_{c} , {σ}_{c}^{2} ) = {\sum }_{i ϵ I}^{ } - \frac{1}{2} {{u}_{i}^{{( c )}^{r}} ( {K}_{u , i}^{( c )} + {σ}_{c}^{2} I )}^{- 1} {u}_{i}^{( c )} - \frac{1}{2} log ( det ( {K}_{u , i}^{( c )} + {σ}_{c}^{2} I ) ) - \frac{\vert {j}_{i}^{( c )} \vert}{2} log 2 π & ( 9 ) \\ log p ( ( {v}_{i}^{( c )} \vert i ∈ I \} \vert {β}_{c}^{2} , {η}_{c} , {ξ}_{c}^{2} ) = {\sum }_{i ϵ I}^{ } - \frac{1}{2} {{v}_{i}^{{( c )}^{r}} ( {K}_{v , i}^{( c )} + {ξ}_{c}^{2} I )}^{- 1} {v}_{i}^{( c )} - \frac{1}{2} log ( det ( {K}_{v , i}^{( c )} + {ξ}_{c}^{2} I ) ) - \frac{\vert {j}_{i}^{( c )} \vert}{2} log 2 π & ( 10 )\end{matrix}$$

Hyperparameters α_{c}², γ_{c}, and σ_{c}² that maximize expression (9), and hyperparameters β_{c}², η_{c}, and ξ_{c}² that maximize expression (10) are estimated. Any optimization method may be used, but for example, optimization problems can be solved using the BFGS method (NPL 3). The above processing is performed regarding each movement means label c∈C, and a set {α_{c}², γ_{c}, σ_{c}², β_{c}², η_{c}, ξ_{c}²|c∈C} of estimated hyperparameters is stored in the hyperparameter storage unit 7. Next, filtering of movement loci contained in the movement means labels is performed using the estimated hyperparameters. When time of day set {tᵢⱼ^{(c)}|j=1, . . . , Jᵢ^{(c)}} is given, a prediction value regarding uᵢ^{(c)} (post-filtering value)

\hat{f}ᵢ^{(c)}=(\hat{f}^{(c)}(t_{i,j=1}), . . . ,\hat{f}^{(c)}(t_{i,j=J}_{ᵢ}_{^{(c)}}))^{T}

becomes expression (11) below, using an average value of prediction distribution of the Gaussian process.

[Formula 10]

\hat{f}ᵢ^{(c)}=K_{u,i}^{(c)}^{^{T}}(K_{u,i}^{(c)}+σ_{c}²I)⁻¹uᵢ^{(c)} (11)

A prediction value regarding uᵢ^{(c)} (post-filtering value)

ĝᵢ^{(c)}=(ĝ^{(c)}(t_{i,j=1}), . . . ,ĝ^{(c)}(t_{i,j=J}_{ᵢ}_{^{(c)}}))^{T}

becomes expression (12) below.

[Formula 11]

ĝᵢ^{(c)}=K_{v,i}^{(c)}^{^{T}}(K_{v,i}^{(c)}+ξ_{c}²I)⁻¹vᵢ^{(c)} (12)

Movement loci filtered by the above procedures are expressed as follows. First, filtered coordinates are expressed as follows.

\hat{x}ᵢⱼ^{(c)}=(\hat{f}^{(c)}(tᵢⱼ),ĝ^{(c)}(tᵢⱼ))

Next, the i'th filtered movement locus included in the movement means label c is expressed as follows.

\hat{D}^{(c)}={\hat{D}ᵢ^{(c)}|i=1, . . . ,I^{(c)}}

Further, movement loci of all labels are collectively expressed as follows.

\hat{D}={\hat{D}^{(c)}|c∈C}

\hat{D}

is stored in the filtered-label-applied movement locus storage unit 8 as filtering results. The filtering unit 6 performs filtering of labeled movement loci as described above.

The feature extracting unit 9 extracts feature vectors from the filtering results of movement loci stored in the label-applied movement locus storage unit 8, for each movement locus.

\hat{D}

is taken as input data, and various types of features are extracted. Any features may be used, such as velocity, angle of change in direction, and so forth. (NPL 1) and so forth, for example, may be referenced regarding the types of features. Here, M represents the count of features used, and ϕᵢ^{(c)} represents an M-dimensional feature vector regarding the i'th movement locus in the movement means label c. All feature vectors are collectively represented by ϕ={ϕᵢ^{(c)}|c∈C; i=1, . . . , I}, and stored in the various features storage unit 10.

The classifier learning unit 11 learns, for each movement means label, a classifier for identifying which movement means label the movement locus is, on the basis of feature vectors extracted regarding movement loci to which the movement means labels have been applied and stored in the various features storage unit 10.

Although any classifier may be used, a case will be described here where multiclass logistic regression (NPL4) is used. In multiclass logistic regression, when a feature vector ϕ^{(c)} is given, posterior probability of the movement means label c is as in expression (13) below.

$$\begin{matrix}[ Formula 12 ] & \\ p ( c \vert {w}_{c} , {φ}^{( c )} ) = \frac{exp ( {a}_{c} ( {φ}^{( c )} ) )}{{\sum }_{{c}^{′} ∈ c} exp ( {a}_{{c}^{′}} ( {φ}^{( {c}^{′} )} ) )} \\ Here , \\ {a}_{c} ( {φ}^{( c )} ) = {w}_{c}^{T} ( {φ}^{( c )} , 1 ) & ( 13 )\end{matrix}$$

holds, and w_{c} represents a M+1-dimensional parameter vector containing a weight and a bias parameter for each feature. Next, a target variable tᵢ=(t_{i,1}, . . . , tᵢ, |c|) is defined as a 1-of-|C| expression where only an element corresponding to the movement means label to which the i'th movement locus belongs is 1, and all others are 0. |C| here represents the count of movement means labels. The likelihood function when labels of all movement loci are given is represented by expression (14) below.

$$\begin{matrix}[ Formula 13 ] & \\ p ( c \vert {w}_{c} , {φ}^{( c )} ) = \frac{exp ( {a}_{c} ( {φ}^{( c )} ) )}{{\sum }_{{c}^{′} ∈ c} exp ( {a}_{{c}^{′}} ( {φ}^{( {c}^{′} )} ) )} & ( 14 )\end{matrix}$$

Note that T is a set of target variables regarding all movement loci, and W={w_{c}|c∈C}. A W, where a log-likelihood function obtained by finding the logarithm of expression (14) is greatest, is obtained on the basis of maximum likelihood estimation. The estimated weight parameter W is stored in the weight parameter storage unit 12 for each movement means label.

Any arrangement may be used for the hyperparameter storage unit 7, the filtered-label-applied movement locus storage unit 8, the various features storage unit 10, and the weight parameter storage unit 12 as long as capable of storing and restoring the above information. Storage is performed in, for example, a database, or a particular region of a general-purpose storage device (memory or hard disk device) provided beforehand.

### <Configuration of Predicting Device According to Embodiment of Present Invention>

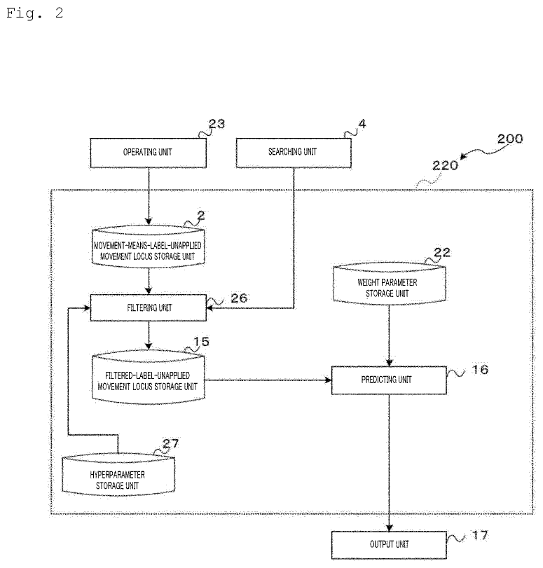

Next, a configuration of a predicting device according to the embodiment of the present invention will be described. The predicting device 200 according to the embodiment of the present invention may be configured of a computer including a CPU, RAM, and ROM storing programs and various types of data for executing a later-described predicting processing routine, as illustrated in FIG. 2. This predicting device 200 functionally is provided with an operating unit 23, a searching unit 4, a computing unit 220, and an output unit 17, as illustrated in FIG. 2.

The operating unit 23 accepts various types of operations from a user regarding data of the movement-means-label-unapplied movement locus storage unit 1.

The searching unit 4 accepts IDs of movement loci that are to be the object of predicting movement means labels. The predicting device 200 outputs a prediction label for a movement locus of an ID specified at the searching unit 4. Note that the input means of the searching unit 4 may be any arrangement, such as a keyboard or mouse, menu screen, arrangement using a touch panel, and so forth. The searching unit 4 can be realized by a device driver of input means such as a mouse or the like, and control software for a menu screen.

The computing unit 220 is configured including a movement-means-label-unapplied movement locus storage unit 2, a filtering unit 26, a hyperparameter storage unit 27, an unfiltered-label-applied movement locus storage unit 15, a weight parameter storage unit 22, and a predicting unit 16.

The movement-means-label-unapplied movement locus storage unit 2 stores data that is the object of prediction of movement means labels, reads out data following requests from the operating unit 23, and transmits this data to the device. An observation contained in a movement locus of which the movement means label is unknown will be represented by (tᵢⱼ*, xᵢⱼ*). With the count of movement loci of which the label is unknown as I* and the count of observations included in an i'th movement locus as Jᵢ*, test data is represented as D*={(tᵢⱼ*, xᵢⱼ*)|i=1, . . . , I*, j=1, . . . , J*}. Assumption is made that one movement means label is assigned to each movement locus. The test data stored in the movement-means-label-unapplied movement locus storage unit 2 is D*. The movement-means-label-unapplied movement locus storage unit 2 is a Web server, a database server provided with a database, or the like.

The hyperparameter storage unit 27 stores parameters relating to the Gaussian process learned by the learning device 100, and parameters relating to noise. Parameters relating to the Gaussian process are scale parameters γ_{c}² and η_{c}² that decide the range of correlation with regard to points around the time of day t, and variance parameters α_{c}² and β_{c}² that decide the magnitude of correlation. Parameters relating to noise are variance parameters σ_{c}² and ξ_{c}² regarding noise.

The filtering unit 26 performs filtering on movement loci, including coordinates for each time of day, and of which the movement means are unknown, stored in the movement-means-label-unapplied movement locus storage unit 2, using parameters relating to the Gaussian process and parameters relating to noise regarding the movement means label, stored in the hyperparameter storage unit 27, for each movement means label. Accordingly, denoising can be performed while taking into consideration whether the filtering is appropriate for the movement means. This will be described in detail below.

A case of performing filtering of Dᵢ* when an i'th unlabeled movement locus Dᵢ*={(tᵢⱼ*, xᵢⱼ*)|j=1, . . . , Jᵢ*} is given will be considered. Assuming that Dᵢ* is movement means label c, a predict ion value (post-filtering value) regarding xᵢⱼ*=(uᵢⱼ*, vᵢⱼ*) is expressed as follows.

\hat{x}ᵢⱼ*^{(c)}=(\hat{f}*^{(c)}(tᵢⱼ*),ĝ*^{(c)}(tᵢⱼ*))

\hat{f}ᵢ*^{(c)}=(\hat{f}*^{(c)}(t_{i,j=1}*), . . . ,\hat{f}*^{(c)}(t_{i,j=J}_{ᵢ}*))^{T}

becomes expression (15) below, using an average value of prediction distribution of the Gaussian process.

[Formula 14]

\hat{f}ᵢ*^{(c)}=K_{u,i}*^{(c)}^{^{T}}(K_{u,i}*^{(c)}+σ_{c}²I)⁻¹uᵢ* (15)

Also,

ĝᵢ*^{(c)}=(ĝ*^{(c)}(t_{i,j=1}*), . . . ,ĝ*^{(c)}(t_{i,j=J}_{ᵢ}*))^{T}

becomes expression (16) below.

[Formula 15]

ĝᵢ*^{(c)}=K_{v,i}*^{(c)}^{^{T}}(K_{v,i}*^{(c)}+ξ_{c}²I)⁻¹vᵢ* (16)

Assuming that the i'th unlabeled movement locus is the movement means label c, the filtered movement locus is expressed as follows.

\hat{D}ᵢ*^{(c)}={(tᵢⱼ,\hat{x}ᵢⱼ*^{(c)})|j=1, . . . ,Jᵢ*}

Further, the results of having performed similar filtering on all movement loci are collectively expressed as follows.

\hat{D}*={\hat{D}ᵢ*|i∈I*}

\hat{D}*

is stored in the filtered-label-unapplied movement locus storage unit 15.

Any arrangement may be used for the filtered-label-unapplied movement locus storage unit 15 as long as capable of storing and restoring the above information. Storage is performed in, for example, a database, or a particular region of a general-purpose storage device (memory or hard disk device) provided beforehand.

Weight parameters W learned at the learning device 100 are stored in the weight parameter storage unit 22.

The predicting unit 16 extracts a feature vector from filtering results of a movement locus, calculates a probability representing which movement means label the movement locus is, using the classifier for identifying which movement means label the movement locus is, the classifier having been learned beforehand for each movement means label, and stored in the weight parameter storage unit 22, and outputs prediction labels regarding movement loci on the basis of the calculation results, for each movement means label.

When the filtered-label-unapplied movement locus

\hat{D}*

is given, the predicting unit 16 configures, for each movement means label, a classifier using the learned weight parameters W for the movement means label stored in the weight parameter storage unit 22, and predicts the probability of each unlabeled movement locus being the movement means that this movement means label indicates, using the classifier. First,

\hat{D}*

is used to extract features in the same way as the processing performed at the feature extracting unit 9. With ϕᵢ*^{(c)} representing a feature vector obtained as a result of performing feature extraction, when ϕᵢ*^{(c)} is given, the probability of the movement means label of the i'th movement locus being c can be calculated by expression (17) below.

$$\begin{matrix}[ Formula 16 ] & \\ p ( c \vert {w}_{c} , {{φ}^{*}}_{i}^{( c )} ) = \frac{exp ( {a}_{c} ( {{φ}^{*}}_{i}^{( c )} ) )}{{\sum }_{{c}^{′} ∈ c} exp ( {a}_{{c}^{′}} ( {{φ}^{*}}_{i}^{( {c}^{′} )} ) )} & ( 17 )\end{matrix}$$

Expression (17) is applied to each movement means label c, and the label with the highest probability is output as the prediction label.

The output unit 17 outputs, on the basis of the predicting unit 16, the movement means label for the unlabeled movement locus specified at the searching unit 4. Output here is a concept that includes displaying on a display, printing at a printer, audio output, transmission to an external device, and so forth. The output unit 17 may be conceived as including or not including an output device such as a display, speaker, or the like. The output unit 17 can be realized by driver software of an output device, or driver software of an output device and the output device, or the like.

### <Operations of Learning Device According to Embodiment of Present Invention>

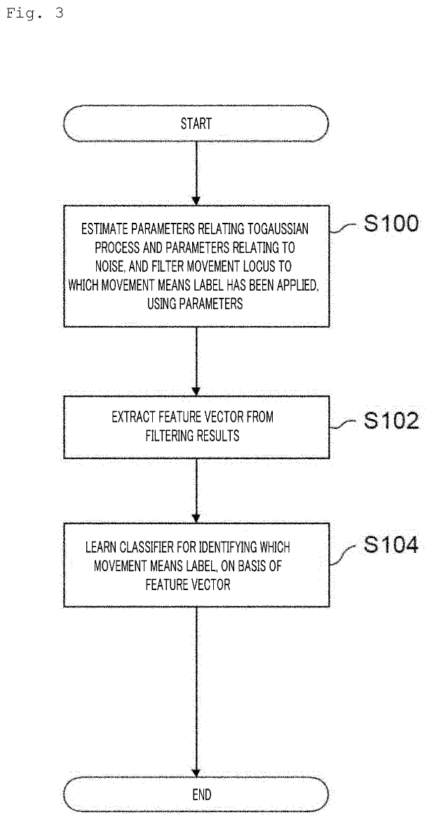

Next, operations of the learning device 100 according to the embodiment of the present invention will be described. The learning device 100 executes a learning processing routine illustrated in FIG. 3.

First, in step S100, parameters relating to a Gaussian process in a case of assuming that the movement locus follows the Gaussian process and parameters relating to noise are estimated using the above expression (9) and expression (10), on the basis of each of movement loci applied with a movement means label and including coordinates for each time of day, stored in the movement-means-label-applied movement locus storage unit 1, for each movement means label. Also in step S100, the above expression (12) is used to perform filtering on the movement locus to which the movement means label has been applied, using the parameters relating to the Gaussian process and parameters relating to noise estimated regarding the movement means label.

Next, in step S102, feature vectors are extracted from filtering results of movement loci stored in the label-applied movement locus storage unit 8, for each movement locus.

In step S104, the above expression (14) is used to learn, for each movement means label, a classifier for identifying which movement means label the movement locus is, on the basis of feature vectors extracted regarding movement loci to which the movement means labels have been applied and stored in the various features storage unit 10, and weighting parameters of the classifier are stored in the weight parameter storage unit 12.

As described above, the learning device according to the embodiment of the present invention estimates parameters relating to a Gaussian process and parameters relating to noise, on the basis of each of movement loci applied with a movement means label and including coordinates for each time of day, for each movement means label, and performs filtering on the movement locus to which the movement means label has been applied, using the estimated parameters. The learning device according to the embodiment of the present invention then extracts feature vectors from the filtering results, and learns a classifier for identifying which movement means label the movement locus is, on the basis of the feature vectors, whereby appropriate denoising can be performed for each movement means, and the classifier for applying movement means labels to movement loci with good precision can be learned.

### <Operations of Predicting Device According to Embodiment of Present Invention>

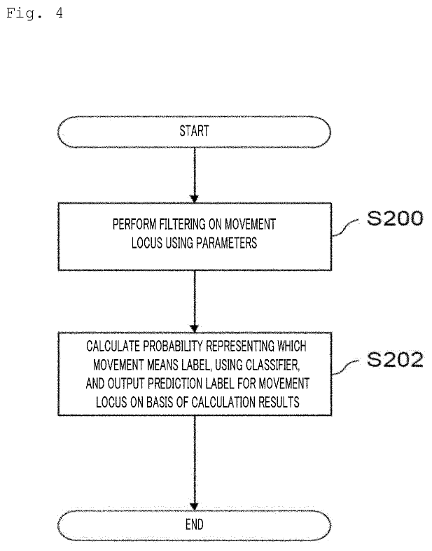

Next, operations of the predicting device 200 according to the embodiment of the present invention will be described. The predicting device 200 executes a predicting processing routine illustrated in FIG. 4.

First, in step S200, filtering is performed on movement loci, including coordinates for each time of day, and of which the movement means are unknown, stored in the movement-means-label-unapplied movement locus storage unit 2, using parameters relating to the Gaussian process and parameters relating to noise regarding the movement means label, stored in the hyperparameter storage unit 27, following expression (15) and expression (16), for each movement means label.

Next, in step S202, feature vectors are extracted from filtering results of movement loci, a probability representing which movement means label the movement locus is, is calculated following expression (17) using the classifier for identifying which movement means label the movement locus is, the classifier having been learned beforehand for each movement means label, and stored in the weight parameter storage unit 22, and prediction labels regarding movement loci on the basis of the calculation results are output, for each movement means label.

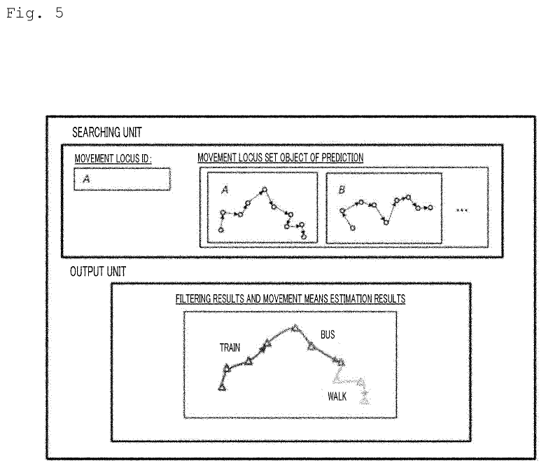

FIG. 5 illustrates an example of a search request made to the searching unit 4 and output from the output unit 17. As illustrated in FIG. 5, an ID of a movement locus that is the object of prediction is accepted at the searching unit in FIG. 5, and a filtered movement locus and predicted movement means label corresponding thereto can be obtained at the output unit in FIG. 2 as output.

As described above, the predicting device according to the embodiment of the present invention performs filtering on movement loci, including coordinates for each time of day, and of which the movement means are unknown, using parameters relating to the Gaussian process and parameters relating to noise, learned beforehand for each movement means label. The predicting device according to the embodiment of the present invention then extracts feature vectors from filtering results of movement loci for each movement means label, and calculates a probability representing which movement means label the movement locus is, using a classifier for identifying which movement means label the movement locus is, the classifier having been learned beforehand for each movement means label. The predicting device according to the embodiment of the present invention then outputs prediction labels regarding movement loci on the basis of the calculation results, whereby a trained classifier can be used to apply movement means labels to movement loci of which movement means are unknown with good precision.

Note that the present invention is not limited to the above-described embodiment, and various modifications and applications may be made without departing from the essence of this invention.

For example, description has been made in the above-described embodiment by way of an example regarding a case where the learning device and the predicting device are separate, but this is not restrictive, and an integrated configuration may be made.

### REFERENCE SIGNS LIST

1 Movement-means-label-applied movement locus storage unit
2 Movement-means-label-unapplied movement locus storage unit
3, 23 Operating unit
4 Searching unit
6, 26 Filtering unit
7, 27 Hyperparameter storage unit
8 Filtered-label-applied movement locus storage unit
9 Feature extracting unit
10 Various features storage unit
11 Classifier learning unit
12, 22 Weight parameter storage unit
15 Filtered-label-unapplied movement locus storage unit
16 Predicting unit
17 Output unit
20, 220 Computing unit
100 Learning device
200 Predicting device

1. A learning device, comprising:
a memory; and
a processor coupled to the memory and configured to:
on the basis of each of movement loci applied with a movement means label and including coordinates for each time of day, estimate parameters relating to a Gaussian process in a case of assuming that a movement locus follows the Gaussian process and parameters relating to noise, for each movement means label;
perform filtering on the movement locus to which the movement means label has been applied, using the estimated parameters relating to the Gaussian process and parameters relating to noise;
extract feature vectors from filtering results of the movement loci, for each of the movement loci; and
learn a classifier for identifying which of the movement means labels the movement locus is, on the basis of the feature vectors extracted regarding the movement loci to which the movement means labels are applied, for each movement means label.

2. The learning device according to claim 1, wherein the parameters relating to the Gaussian process include scale parameters that decide the range of correlation with regard to points around the time of day, and variance parameters that decide the magnitude of correlation, and the parameters relating to noise include variance parameters relating to noise.

3. A predicting device, comprising:
a memory; and
a processor coupled to the memory and configured to:
perform filtering on movement loci, including coordinates for each time of day, and of which movement means are unknown, using parameters relating to a Gaussian process and parameters relating to noise, the parameters learned beforehand for each movement means label; and
extract a feature vector from the filtered results of a movement locus for each movement means label;
determine a probability representing which of the movement means labels the movement locus is, using a classifier for identifying which of the movement means labels the movement locus is, the classifier having been learned beforehand for each movement means label; and
provide a prediction label for the movement locus on the basis of calculation results.

4. A computer-implemented method, the method comprising:
estimating, on the basis of each of movement loci applied with a movement means label and including coordinates for each time of day, parameters relating to a Gaussian process in a case of assuming that the movement locus follows the Gaussian process and parameters relating to noise, for each movement means label;
performing filtering on the movement locus to which the movement means label has been applied, using the estimated parameters relating to the Gaussian process and parameters relating to noise;
extracting unit extracting feature vectors from filtering results of the movement loci, for each of movement loci; and
learning a classifier for identifying which of the movement means labels the movement locus is, on the basis of the feature vectors extracted regarding the movement loci to which the movement means labels are applied, for each movement means label.

5. The computer-implemented learning method according to claim 4, wherein the parameters relating to the Gaussian process include scale parameters that decide the range of correlation with regard to points around the time of day, and variance parameters that decide the magnitude of correlation, and the parameters relating to noise include variance parameters relating to noise.

6. The computer-implemented method of claim 4, the method further comprising:
filtering on movement loci, including coordinates for each time of day, and of which the movement means are unknown, using parameters relating to a Gaussian process and parameters relating to noise, learned beforehand for each movement means label; and
extracting a feature vector from filtering results of a movement locus for each movement means label;
determining a probability representing which of the movement means labels the movement locus is, using a classifier for identifying which of the movement means labels the movement locus is, the classifier having been learned beforehand for each movement means label; and
providing a prediction label for the movement locus on the basis of determined probability.

7. (canceled)

8. The learning device of claim 2, wherein the noise includes a first noise associated with the movement locus based on walking and a second noise associated with the movement locus using a train, and wherein the filtering of the movement locus based on walking is distinct from the filtering of the movement locus based on using the train.

9. The learning device of claim 2, wherein the movement means label includes one of: a walk, a train, and a car.

10. The learning device of claim 2, wherein the prediction label includes one of: a walk, a train, and a car.

11. The learning device of claim 2, wherein the classifier uses a multiclass logistic regression for determining a posterior probability of the movement means label based on the feature vector.

12. The predicting device of claim 3, wherein the noise includes a first noise associated with the movement locus based on walking and a second noise associated with the movement locus using a train, and wherein the filtering of the movement locus based on walking is distinct from the filtering of the movement locus based on using the train.

13. The predicting device of claim 3, wherein the movement means label includes one of: a walk, a train, and a car.

14. The predicting device of claim 3, wherein the prediction label includes one of: a walk, a train, and a car.

15. The predicting device of claim 3, wherein the classifier uses a multiclass logistic regression for determining a posterior probability of the movement means label based on the feature vector.

16. The computer-implemented method according to claim 4, wherein the noise includes a first noise associated with the movement locus based on walking and a second noise associated with the movement locus using a train, and wherein the filtering of the movement locus based on walking is distinct from the filtering of the movement locus based on using the train.

17. The computer-implemented method according to claim 4, wherein the movement means label includes one of: a walk, a train, and a car.

18. The computer-implemented leaning method according to claim 4, wherein the prediction label includes one of: a walk, a train, and a car.

19. The computer-implemented method according to claim 4, wherein the classifier uses a multiclass logistic regression for determining a posterior probability of the movement means label based on the feature vector.

20. The computer-implemented method according to claim 4, the method further comprising:
predicting, based on the determining probability representing which of the movement means labels the movement locus is, a prediction label for the movement locus.

21. The computer-implemented method according to claim 20, the method further comprising:
receiving the moving locus, wherein the moving locus includes a segment without one of the movement means labels associated with the segment, and wherein the moving locus includes a plurality of positional coordinates of a location, a time associated with the location, and a movement means label;
providing the predicted prediction label for the moving locus.
